(19) United States
(12) Patent Application Publication
(10) Pub. No.: US 2026/0134555 A1
(43) Pub. Date: May 14, 2026

(54) OBJECT OF INTEREST MOTION DETECTOR

(71) Applicant: ObjectVideo Labs, LLC, Tysons, VA (US)

(72) Inventors: Eduardo Romera Carmena, Madrid (ES); Allison Beach, Leesburg, VA (US); Gang Qian, McLean, VA (US)

(21) Appl. No.: 19/372,533

(22) Filed: Oct. 29, 2025

Related U.S. Application Data
(60) Provisional application No. 63/720,353, filed on Nov. 14, 2024.

(51) Int. Cl. G06T 7/254; G01P 13/00; G06T 7/246

(52) U.S. Cl. CPC G06T 7/254; G01P 13/00; G06T 7/248; G06T 2207/10024; G06T 2207/20081; G06T 2207/20224

(57) ABSTRACT

Methods, systems, and apparatus, including computer programs encoded on computer storage media, for detecting motion of an object or event of interest. One of the methods includes maintaining a first image captured by a camera; maintaining, for each of one or more second images, a corresponding difference image generated from the first image and the corresponding second image; providing, to a deep motion detector trained to detect motion for an object of interest and to cause the deep motion detector to generate output, the one or more difference images and color image data for the first image; receiving, from the deep motion detector, output that indicates whether the first image likely depicts motion for an object of interest; and performing one or more automated actions using the output that indicates whether the first image likely depicts motion for an object of interest.

### CROSS-REFERENCE TO RELATED APPLICATION

This application claims the benefit of U.S. Provisional Application No. 63/720,353, filed on November 14, 2024, the contents of which are incorporated by reference herein.

### BACKGROUND

Some devices can detect motion and trigger one or more actions. For instance, a security camera can detect motion depicted in a sequence of images captured by the security camera and generate a corresponding security alert.

### SUMMARY

In general, one innovative aspect of the subject matter described in this specification can be embodied in methods that include the actions of maintaining a first image captured by a camera; maintaining, for each of one or more second images, a corresponding difference image generated from the first image and the corresponding second image; providing, to a deep motion detector trained to detect motion for an object of interest and to cause the deep motion detector to generate output, the one or more difference images and color image data for the first image; receiving, from the deep motion detector, output that indicates whether the first image likely depicts motion for an object of interest; and performing one or more automated actions using the output that indicates whether the first image likely depicts motion for an object of interest.

In general, one innovative aspect of the subject matter described in this specification can be embodied in methods that include the actions of, for at least one training image: maintaining a reference image that depicts the same physical region as the corresponding training image; computing a motion score that represents a ratio of a number of reference points that are at different locations in the reference image and the corresponding training image to a total number of reference points; determining whether the motion score satisfies a score criterion; and selectively labeling the corresponding training image as depicting motion or not depicting motion using a result of the determination whether the motion score satisfies the score criterion; and updating a deep motion detector using the at least one training image as input during a training process.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, the method can include receiving, from a camera that captured the first image, the first image; and computing, for each of the one or more second images, the corresponding difference image. Computing the corresponding difference image can include: downsampling a luminance value from the first image; for at least some of the one or more second images: downsampling a luminance value from the corresponding second image; and computing the corresponding difference image that indicates a difference between the downsampled luminance value from the first image and the downsampled luminance value from the corresponding second image. The method can include converting an image from an RGB color model to a YUV color model, the image comprising one of the first image or one of the one or more second images. Downsampling the luminance value can include downsampling the luminance value of the image in the YUV color model.

In some implementations, providing the one or more difference images and the color image data can cause the deep motion detector to combine first data for the one or more difference images with second data for the color image data. Receiving the output can include receiving the output generated using the combination of the first data and the second data.

In some implementations, the deep motion detector can include one or more convolutional layers, one or more downsampling layers, and one or more spatial attention modules. Receiving the output can include receiving the output generated by processing a) at least some of the one or more difference images with at least one of the one or more spatial attention modules to generate the first data, b) third data for the color image data with at least one of the one or more convolutional layers to generate convolutional output data, and c) at least some of the convolutional output data with at least one of the one or more downsampling layers to generate the second data.

In some implementations, receiving the output can include receiving the output generated by processing difference image data from the one or more difference images with each of the one or more spatial attention modules.

In some implementations, the deep motion detector can include one or more residual layers. Receiving the output can include receiving the output generated by processing the combination of at least some of the first data and at least some of the second data with at least one of the one or more residual layers. Receiving the output can include receiving the output generated by processing a final residual output from the one or more residual layers with one or more global average pool layers, one or more fully connected layers, or both. Receiving the output can include receiving the output generated by processing a final residual output from the one or more residual layers with one or more global average pool layers and one or more fully connected layers. Receiving the output can include receiving the output generated by processing, with at least one of the one or more residual layers, the first data concatenated with the second data.

In some implementations, maintaining the corresponding difference image can include maintaining, for each of two or more second images, the corresponding difference image generated from the first image and the corresponding second image. Providing the one or more difference images and the color image data can include providing, to the deep motion detector trained to detect motion for an object of interest and to cause the deep motion detector to generate output, the two or more difference images and color image data for the first image.

In some implementations, performing the one or more automated actions can include transmitting, to another system, a message that indicates that motion of an object of interest was detected in response to determining that the output indicates that the image likely depicts motion for an object of interest.

In some implementations, receiving the output can include receiving, from the deep motion detector, output that indicates, for each of multiple categories of objects of interest, whether the first image likely depicts motion for the respective category of an object of interest. Performing the one or more automated actions can include providing, to an object detector, the output that includes a value for each of the multiple categories of interest to cause the object detector to detect an object depicted in the first image.

In some implementations, performing the one or more automated actions can include removing the image from motion analysis of the first image for an object of interest in response to determining that the output indicates that the image likely does not depict motion for an object of interest.

In some implementations, the method can include providing the updated deep motion detector to another system to cause the other system to use the deep motion detector to detect motion.

In some implementations, computing the motion score can include , for each of one or more objects of interest depicted in the corresponding training image, computing the motion score that represents the ratio of the number of reference points for the corresponding object of interest that are at different locations in the reference image and the corresponding training image to the total number of reference points. Determining whether the motion score satisfies the score criterion can include determining whether at least one of the motion scores for the one or more objects of interest satisfy the score criterion.

In some implementations, selectively labeling the corresponding training image as depicting motion or not depicting motion can use the result of the determination whether at least one of the one or more motion scores, each for a corresponding object of interest depicted in the corresponding training image, satisfy the score criterion.

In some implementations, the method can include receiving input defining the one or more objects of interest; and detecting, for an image from the at least one training image, the reference points using data for the one or more objects of interest. Updating the deep motion detector can use a training process to cause the deep motion detector to detect motion of the one or more objects of interest.

In some implementations, the total number of reference points can be a total number of reference points in the corresponding training image.

In some implementations, the score criterion can have a value of approximately 0.85.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, a deep motion detector, or a system or device that uses the deep motion detector, as described in this specification can more accurately detect motion for events, objects, or both, of interest compared to other systems. A deep motion detector can receive, as input, data for one or more color images, one or more difference images, or both, for improved accuracy. For instance, by using, as at least part of the input, color image data, e.g., data for one or more color images, the deep motion detector can more accurately discriminate between categories of objects, e.g., people, animals, vehicles, and trees, to name a few examples. In some instances, the color image data can enable the deep motion detector to discriminate between subcategories, e.g., when the deep motion detector is trained to detect events of interest that include larger animals such as deer and bears and not smaller animals like squirrels. The color data can contain texture information that is not included in a different image. The texture data can include, e.g., data that represents clothes, fur, color variations, or a combination of these, to name a few examples. By more accurately discriminating between categories and subcategories, the deep motion detector can more accurately determine whether a motion event is a motion event of interest, e.g., that includes motion of an object of interest.

In this specification, when the deep motion detector more accurately discriminates between two things or detects motion of interest, compared to other systems, the output generated by the deep motion detector can be more accurate. As a result of more accurate output, whether because of discrimination or something else, the system or device that includes the deep motion detector can be more accurate, since such a system or device would be using the more accurate data generated by the deep motion detector.

In some implementations, the deep motion detector can more accurately detect motion of an event of interest by using data for multiple images. For example, by using data for multiple, e.g., two or more, difference images, the deep motion detector can more accurately detect motion of interest. For instance, difference images, each of which are generated from a current image and a corresponding reference image, can represent characteristics of objects depicted in the current image, such as a speed of an object. This can enable the deep motion detector to more accurately determine whether motion depicted in the current image is for an event of interest. For example, the deep motion detector can more accurately discriminate what events are an actual motion event triggered by an object of interest, versus what events are being falsely trigger from background noisy motion, e.g., vegetation constantly swaying in the background.

In some implementations, by using both color image data and data for multiple difference images, the deep motion detector can both more accurately detect objects of interest, using the color image data, and more accurately detection motion of interest, e.g., using data for multiple difference images.

In some implementations, by using a combination of color image data for a current image and data for multiple difference images, the deep motion detector can be more efficient compared to other systems. This can result in a great efficiency of the system or device that implements the deep motion detector. For instance, the deep motion detector, or a device implementing the deep motion detector, can consume less power, e.g., operate in a very low power mode, reduce thermal demands on a device that implements the deep motion detector, or both. Reduced thermal demands can reduce a likelihood that the device, e.g., camera, will malfunction when the device operates in a hot climate, e.g., that might cause damage to the device. This can occur when the camera is located outdoors in direct sunlight. In some examples, by using the deep motion detector for initial analysis, the device can more efficiently use resources for analysis by a more robust, downstream engine, e.g., an object detector, that consumes more resources than the deep motion detector. For instance, the device can perform initial analysis with the deep motion detector and then, when the deep motion detector detects motion, an object, or both, of interest, perform analysis by the downstream engine. This can be enabled by the deep motion detector generating output that includes multiple values for different categories of interest.

In some implementations, the deep motion detector can perform operations that might have been performed by different engines previously. For instance, the deep motion detector can generate output that includes a value for each of multiple different categories. This can reduce processing required by a downstream engine or system, saving computational resources.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a camera uses a deep motion detector to detect motion.

FIG. 2 depicts an example motion detection engine.

FIG. 3 is a flow diagram of a process for using a motion detector

FIG. 4 is a diagram illustrating an example of a property monitoring system.

Like reference numbers and designations in the various drawings indicate like elements.

### DETAILED DESCRIPTION

Security systems can use cameras to detect events of interest. Some event detection is triggered when a camera detects motion. However, not all types of motion are indicative of events of interest, e.g., for which a security action might be performed. For instance, movement of a plant or small animal, e.g., a squirrel, might not be associated with a security action.

To enable a system, e.g., a camera or a cloud system, to detect motion more accurately for events of interest, the system can use a deep motion detector that implements a motion detection model. The system can provide, as input to the deep motion detector, texture deep features and one or more difference images. The deep motion detector can provide the input to one or more layers in the motion detection model. The one or more layers can include one or more convolutional layers, one or more downsampling layers, one or more spatial attention modules, one or more residual layers, or any combination of these.

The system can receive, as output generated by the deep motion detector, a vector that indicates whether potential motion of interest was detected. The vector can include one or more values for types of motion of interest, e.g., motion caused by people, animals, vehicles, or any combination of these. The vector can include a value for non-motion of interest. For instance, the vector can be in the form of “[no-motion, person, animal, vehicle]”, with corresponding values indicating the likelihood that the image corresponds to motion of interest for the corresponding category. The categories can be in any appropriate order in the vector. An image can have a high non-motion of interest score when the image likely does not depict any motion, or depicts motion of an object that is not an object of interest, e.g., motion of a spider web or a plant.

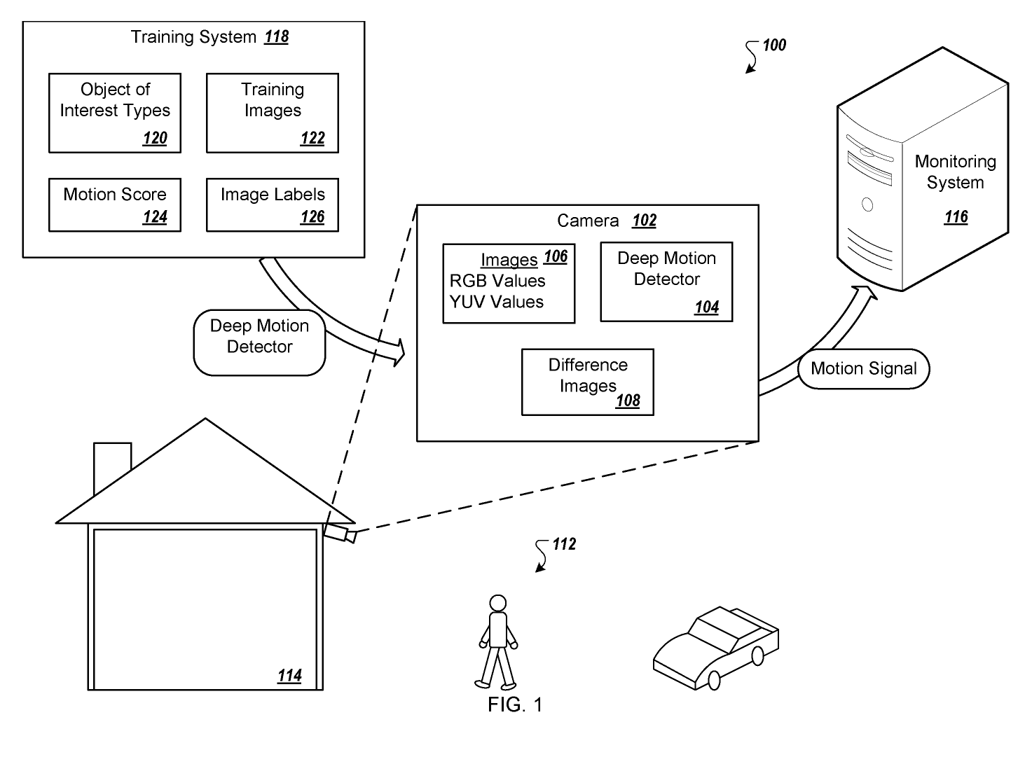

FIG. 1 depicts an example environment 100 in which a camera 102 uses a deep motion detector 104 to detect motion. The camera 102 can provide the deep motion detector 104, e.g., that implements a machine learning module on the hardware of the camera, with multiple inputs such as one or more images 106, one or more difference images 108, or both. In some instances, the camera 102 can provide data, e.g., downsampled data, that represents the one or more images 106, e.g., instead of or in addition to the images 106 themselves. The deep motion detector 104 processes the input to generate one or more output values that represent a likelihood of detected motion. The camera 102 receives the output and performs one or more actions given the output.

The camera 102 is physically located at a property 112. For instance, the property 112 can be a home or a business and can have one or more buildings 114 on the property 112. The camera 102 can be attached to the outside of a building 114, a post, the inside of a building 114, or at another appropriate location.

The camera 102 captures one or more images 106 of scenes within a field of view of the camera. The captured images 106 can depict any appropriate type of objects, such as plants, animals, people, vehicles, and the sky.

The camera 102 provides data about the captured images 106 to the monitoring system 116. The data can include the images 106, a subset of the images 106, feature vectors for the images 106, or any appropriate combination of these.

To reduce an amount of data transmitted to the monitoring system 116 to improve an accuracy of actions performed by the monitoring system 116 or both, the camera 102 can provide a subset of the captured images 106. To select the subset of the captured images 106, the camera 102 can use the deep motion detector 104 that is trained to detect motion of events, objects, or both, of interest. Some examples of objects of interest can include people, animals, vehicles, or any combination of these. In some instances, instead of all animals being objects of interest only a subset of animals are objects of interest, e.g., animals whose size satisfies a size threshold. In these instances, squirrels might not be objects of interest while bears are objects of interest.

This can improve an accuracy of the monitoring system 116 by causing the monitoring system 116 to perform actions for only a subset of detected motion or objects instead of all detected motion and objects. For instance, the camera 102 can capture a sequence of images that depict movement of a tree branch in the wind. Although the deep motion detector 104 is trained to detect motion, the monitoring system 116 should not perform an action for this detected movement, e.g., it might cause a false alarm. As a result, the camera 102 can use the deep motion detector 104 to select the subset of the captured images 106.

The images 106 can have any appropriate type of encoding. For instance, the images 106 can be captured with RGB, BGR, or YUV values.

The camera 102 can generate difference images 108, color images 106, or both. In examples in which the images 106 are captured with RGB or BGR values, the camera 102 can convert those values to YUV values. The camera 102 can use the luminance Y values from the YUV values to compute the difference images 108.

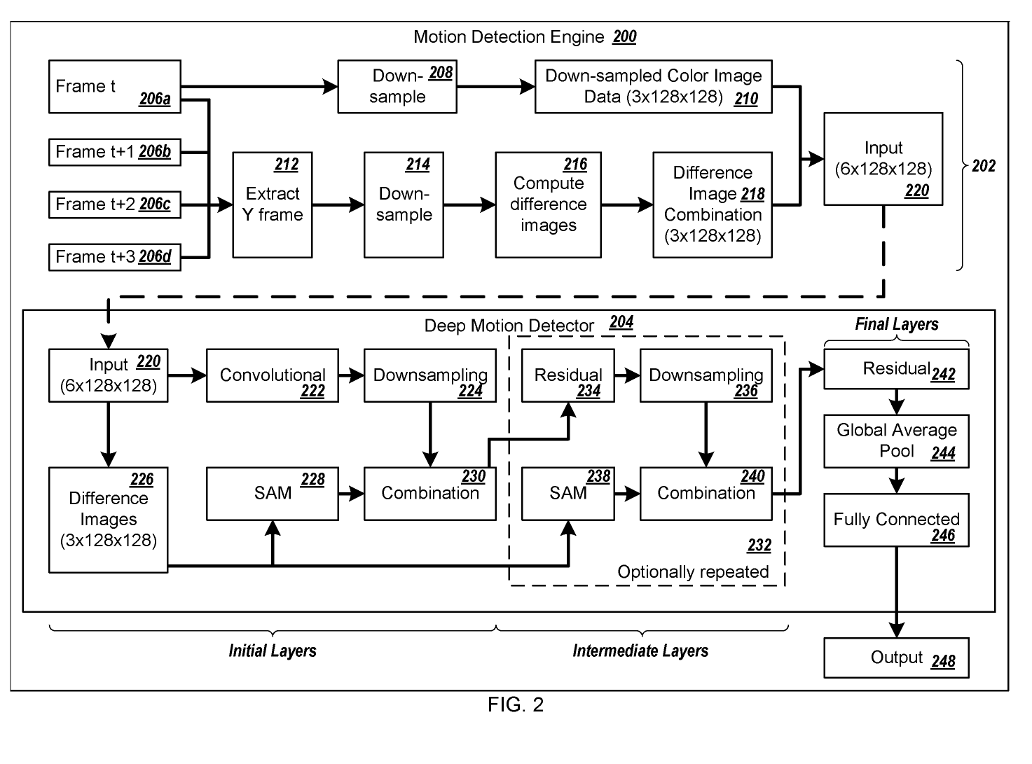

The camera 102 can provide the difference images 108, data for the color images 106, or any combination of these, as input to the deep motion detector. Details of the difference images 108 and the data for the color images 106, along with an example implementation of the deep motion detector 104, are described in more detail below with reference to FIG. 2.

In response to providing the input, the camera 102 receives output from the deep motion detector 104. The output indicates whether any motion was likely detected given the input data. For instance, the input data can represent data from multiple images. In some examples, the input data can include the color image 106 for a first image and one or more difference images 108 generated from second images, optionally in combination with the first image. By processing the data from the multiple images, the deep motion detector 104 can detect motion across images.

The camera 102 can process the output data to determine whether the output data indicates that some of the images used to generate input data likely depicted motion for an object of interest, e.g., that motion of interest was likely detected. Upon determining that the output indicates that none of the images likely depicted motion of interest, the camera 102 can remove at least some of the images used to generate the input data from motion of interest analysis. For instance, when the camera 102 generates input data from a first image and a second, subsequent image, the camera 102 can remove the first image from motion analysis, e.g., delete the first image from memory on the camera 102. Although some examples might refer to a second image or a reference image as a subsequent image, some examples might use a second image or a reference image that was captured prior to the current image.

Upon determining that the output indicates that some of the images likely depicted motion of interest, the camera 102 can transmit a message to another component in the camera, the monitoring system 116, or both, that indicates that motion of interest was detected. For example, the camera 102 can transmit a motion signal to the monitoring system 116 which motion signal includes data about the detected motion. In some examples, the camera 102 can provide data to a downstream engine, e.g., an object detector, that will analyze the data. The data in one or both of these instances can include one or more of the images, second data generated from the images, or both, for the images that were used as the input to the deep motion detector as part of the motion detection process that generated the output.

Provision of the motion signal to the monitoring system 116 can cause the monitoring system 116 to perform one or more automated actions. For instance, the monitoring system 116 can trigger an alarm, provide a message for presentation on a client device, trigger an interaction with a person at the property 112, e.g., who is depicted in at least some of the images used for the input, or any combination of these.

The deep motion detector 104 can be trained to detect motion of interest. Motion of interest can be motion that is caused by an object of interest, e.g., a person, an animal, or a vehicle. This is in contrast to any type of motion that can be caused by objects that are not objects of interest, e.g., a tree, a garbage can, or water. Since the camera 102 can continuously process images captured by the camera 102, e.g., 24/7, the camera 102 can use the deep motion detector 104 as a lightweight engine to analyze the images, compared to a more robust downstream engine that is not a lightweight engine and requires more computational resources to analyze images. This analysis by the deep motion detector 104 can filter the number of images that the camera 102 sends to the downstream engine for analysis. As a result of this use of the deep motion detector that generates output for motion of interest, the camera 102 can save energy compared to systems that use the more robust downstream engine, e.g., an object detector, on all images, that flag any image that depicts motion, or both.

The camera 102 can analyze, with the deep motion detector 104, every image, or images according to a periodicity, e.g., every fifth image. Using the output from the deep motion detector 104, the camera 102 would analyze only a subset of these images with the downstream engine.

The downstream engine can be any appropriate type of engine. For instance, the downstream engine can be an object detector that require more computational resources to analyze images. As a result, the camera 102 can initially use the deep motion detector 104 to initially analyze one or more images, consuming less power during this process. For the images that the deep motion detector 104 flags as likely depicting motion of interest, the camera 102 can provide data for those images to the downstream engine that will perform additional analysis on the image, consuming more energy as part of this additional analysis.

In some examples, an object detector can determine if the image depicts an object of any of one or more predefined object of interest classes, e.g., person, animal, and vehicle. The object detector, upon detecting an object of interest, can generate output that indicates the class of the object and a bounding box location of the object. The deep motion detector 104 is not trained to detect bounding box locations. The camera 102 can use the bounding box location information for additional processing, e.g., object tracking to monitor the movement of the object in the scene depicted in the images captured by the camera 102.

The deep motion detector 104 can be trained using any appropriate type of process. For instance, a training system 118 can train an initial model that implements the deep motion detector 104. The training system 118 can train the initial model using any appropriate combination of one or more object of interest types 120, multiple training images 122, one or more motion scores 124, or one or more image labels 126.

The training images 122 can be images from multiple video clips. The training system 118 can use combinations of images from a single video clip as input to the deep motion detector 104 to enable the deep motion detector 104 to detection motion across images.

The training system 118 can maintain, for at least some, e.g., all, of the training images, bounding boxes that each surround an object that has one of the object of interest types 120. These types can include person, animal, vehicle, or any combination of these.

The training system 118 can process a current training image from a video clip using data from subsequent images in the video clip. In some instances, given a minimum number of subsequent images in the video clip necessary for training, and inference, the deep motion detector 104 does not process all images from a video clip as training images. For instance, when the deep motion detector 104 uses three subsequent images, the deep motion detector 104 processes all earlier images in the video clip as training images excluding the three last images in the video clip.

The training system 118 extracts key points for the bounding boxes included in a current image, e.g., as a training image. This can include the training system 118 cropping the region of the image to only include the content inside a corresponding bounding box, e.g., as a subregion. In some instances, the training system 118 can crop the region of the image for each bounding box associated with a current image. In some implementations, the training system 118 can crop the image using only bounding boxes for objects that have a type from the object of interest types 120, or only maintain the subregions for objects that have a type from the object of interest types 120. The training system 118 can perform this latter type of cropping using one or more masks or other appropriate data for the objects that have a type from the object of interest types 120, e.g., for foreground objects. This can occur by the training system 118 performing an initial cropping using a bounding box and then applying a mask to the cropped subregion. This can increase a likelihood that the deep motion detector 104 more accurately detects motion of objects of interest, does not output a value indicating motion based solely on background objects, or both. The training system 118 can keep, for the cropped image, the content from the image that is both in the bounding box and not excluded by, e.g., outside, the mask. The training system 118 can detect the key points in the cropped subregions. The training system 118 can use any appropriate process to detect the key points.

The training system 118 can compute a scale-invariant feature transform (“SIFT”) descriptor for one or more of the key points. The training system 118 can use any appropriate process to compute the SIFT descriptors for the one or more, e.g., all, key points.

The training system 118 can select one or more subsequent images, e.g., reference images, for the current image. For instance, when the current image is for time t in the video clip, the training system 118 can select the subsequent images at times t +1, t+2, and t+3. t+1 can be 100 milliseconds (“ms”) after the time t for the current image. t+2 can be 200 ms after the time t for the current image. t+3 can be 333 ms after the time t for the current image.

The training system 118 can compute, for each of the one or more subsequent images, corresponding SIFT descriptors. The training system 118 can use the detected key points for the current image to compute the SIFT descriptors for each of the one or more subsequent images.

The training system 118 can compute, for each of the one or more subsequent images, the distance between matching key points in the current image and corresponding subsequent image. The training system 118 can use any appropriate process to match the key points, e.g., Brute-Force matcher. The distance between matching key points can represent a degree to which there was movement of the key point between the current image and the corresponding subsequent image. The training system 118 can compute the distances for multiple subregions in the images, e.g., when the images depict multiple objects of interest.

The training system 118 can compute a motion score 124 for the current image. The motion score can represent a likelihood that the current image depicts an object of interest for which there is motion. The training system 118 can compute the motion score as a ratio of a number of reference points that are at different locations in the subsequent image, e.g., reference image, and the current image, e.g., training image, to a total number of reference points. The total number of reference points can be the reference points in the current image. The training system 118 can compute the motion score using data for multiple, e.g., all, subregions of the current image.

The motion score can be any appropriate value. For instance, the motion score can be a value between 0.0 and 1.0 inclusive. A motion score of 0.0 can indicate that none of the key points in the current image, a subregion of the current image, or both, were at the same location in the current image and the corresponding subsequent image, e.g., none of the key points matched so all of them likely moved. A motion score of 1.0 can indicate that all of the key points in the current image, a subregion of the current image, or both, were at the same location in the current image and the corresponding subsequent image, e.g., all the key points matched so none of them moved.

The training system 118 can determine whether the motion score satisfies a score criterion. The score criterion can be a value selected to allow for some keypoints between images that might not be correctly matched, e.g., due to artifacts or distortions in one or both of the images, and that motion in small portions of an object should not imply that the whole object is necessarily moving, e.g., when a person waves their hand while standing still. The score criterion can be any appropriate value, e.g., a value between 0.0 and 1.0. For instance, the score criterion can be 0.85.

When the motion score does not satisfy the score criterion, the training system 118 can determine that the current image likely does not depict sufficient motion, e.g., or any motion, of an object of interest and that the deep motion detector 104 should output a value that indicates detected motion for the current image during a training process. The training system 118 can label, as one of the image labels 126, the current training image as an image that does not depict motion, e.g., in the sense that motion relates to motion of an object of interest. In some examples, the motion score does not satisfy the score criterion when the motion score is greater than or equal to the score criterion.

When the motion score satisfies the score criterion, the training system 118 can determine that the current image likely depicts sufficient motion of an object of interest and that the deep motion detector 104 should output a value that indicates detected motion for the current image during a training process. The training system 118 can label, as one of the image labels 126, the current training image as an image that depicts motion. In some instances, the motion score satisfies the score criterion when the motion score is less than the score criterion.

The training system 118 can use the image labels 126, generated using the motion scores 124, and the training images 122 during a training process of the deep motion detector 104. The training system 118 can use the image labels 126 as the desired output for a supervised learning process of the deep motion detector 104.

In some implementations, the training system 118 can compute a distance, a motion score 124, or both, for each object depicted in a current image. When the training system 118 determines that all of the motion scores for a current image do not satisfy the score criterion, the training system 118 can determine that the current image likely does not depict sufficient motion. When at least one of the motion scores for the current image satisfies the score criterion, the training system 118 can determine that the current image likely depicts motion.

In some implementations, the training system 118 can generate a motion label that indicates the object of interest type 120 for the motion. In these implementations, the training system 118 can generate multiple labels for a single current image, e.g., when that image depicts multiple objects of different types that likely have motion. For instance, when an image depicts a person walking their dog and the training system 118 determines that the image likely depicts motion, the training system 118 can label the image as “person and animal motion” or with two separate labels of “person motion” and “animal motion.”

In some implementations, the training system 118 can determine to skip one or more operations in the training process. For instance, when the training system 118 determines that there are no key points in a current image, the training system 118 can determine to label the image as no motion and skip computing a motion score 124 for the current image. In some instances, the training system 118 can assign the current image that does not have any key points a motion score that does not satisfy the score criterion, e.g., a value of 1.0 or 2.0.

After training the deep motion detector 104, the training system 118 provides the deep motion detector 104 to the camera 102. This provision can occur during production of the camera 102, initial setup of the camera 102, as an update to the software implemented on the camera 102, or any combination of these.

The camera 102, the training system 118, or both, is an example of a system implemented as computer programs on one or more computers in one or more locations, in which the systems, components, and techniques described in this specification are implemented. The network (not shown), such as a local area network (“LAN”), wide area network (“WAN”), the Internet, or a combination thereof, connects the camera 102, the monitoring system 116, and the training system 118. The training system 118, the cloud computing system, or both, can use a single computer or multiple computers operating in conjunction with one another, including, for example, a set of remote computers deployed as a cloud computing service.

The camera 102 is one example of a system that can use a deep motion detector 104. Other types of systems can include a monitoring system 116, a cloud computing system (not shown), or any appropriate combination of devices and systems including a combination of the systems described in this specification. For instance, the camera 102 can perform some operations while the cloud computing system performs other operations. In cloud computing implementations, the deep motion detector 104 can be implemented on one or more physical computers.

The camera 102 can include several different functional components, including the deep motion detector 104. The deep motion detector 104 can include one or more data processing apparatuses, can be implemented in code, or a combination of both. For instance, the deep motion detector 104 can include one or more data processors and instructions that cause the one or more data processors to perform the operations discussed herein.

The camera 102, the training system 118, or both, can implement a database to store data. For instance, the camera 102 can maintain the images 106, data for the images 106, e.g., downsampled image data, the difference images 108, or any combination of these in one or more databases. The training system 118 can maintain data representing the object of interest types 120, the training images 122, the motion scores 124, the image labels 126, or any combination of these, in one or more databases.

FIG. 2 depicts an example motion detection engine 200. The motion detection engine 200 includes a deep motion detector 204 that is one example of the deep motion detector 104 of the environment 100. The motion detection engine 200 can be implemented on an edge device, e.g., a camera, a backend system, e.g., the cloud, or a combination of both. The motion detection engine 200 can detect motion in an image and trigger one or more actions.

The motion detection engine 200 includes a pre-processing pipeline 202. The pre-processing pipeline 202 receives one or more images, e.g., frames 206a-d, from a camera or a component included in the camera, e.g., an image sensor. The pre-processing pipeline 202 processes the frames 206a-d to generate input 220 for the deep motion detector 204.

The frames 206a-d can include any appropriate number of frames. For instance, the frames 206a-d can include a first frame t 206a captured by the camera at time t. The frames 206a-d can include one or more second frames 206b-c captured after time t. For instance, the camera can capture at least some of the second frames 206b-c at times t+1, t+2, and t+3. These times can be the times after time t as discussed in more detail above.

The motion detection engine 200 can perform one or more operations on the frame t 206a. For instance, the motion detection engine 200 can down-sample 208 the frame t 206a, e.g., to 128x128 pixels. The initial resolution of the images can be any appropriate resolution. For instance, since the motion detection engine 200 can be implemented on different types of cameras, the initial resolution of the images can vary based on the resolution of the images captured by the cameras. In some instances, the camera can perform a pre-processing operation that down-samples captured images from an initial resolution to an intermediate resolution, which intermediate resolution is then downsampled to the resolution of the image data processed by the deep motion detector 204.

The motion detection engine 200 can generate down-sampled color image data 210 for the downsampled frame t. The down-sampled color image data 210 can be a matrix with a size of 3x128x128. This matrix can include one two-dimensional 128x128 matrix for each color, e.g., RGB or BGR. In some examples, the down-sampled color image data 210 can include raw pixel values, e.g., from the corresponding image encoding.

The motion detection engine 200 can perform one or more operations using the second frames t+1, t+2, and t+3 206b-c. These operations can include operations that optionally include the use of the first frame t 206a. For instance, the motion detection engine 200 can maintain YUV encodings for each of the frames 206a-d. In implementations in which the frames 206a-d are captured in a different encoding, e.g., RGB, the motion detection engine 200 can convert the frames 206a-d from the different encoding into a YUV encoding. The motion detection engine 200 can extract, for each of the frames 206a-d, the corresponding Y sub-frame 212. By extracting the Y sub-frame, the motion detection engine 200 can reduce computational resources required for additional processing, e.g., because the Y sub-frame takes up less memory, and requires fewer computational cycles for processing, than the entire frame.

The motion detection engine 200 down-samples the extracted Y sub-frames 214. For instance, the motion detection engine 200 down-samples the extracted Y sub-frames each of which were extracted for one of the frames 206a-d. The down-sampled Y sub-frames can have a size of 128x128 pixels.

The motion detection engine 200 computes difference images 216 from the down-sampled Y sub-frames. In implementations in which the motion detection engine 200 uses three second frames 206b-d, the motion detection engine 200 can compute three difference images 216. The motion detection engine 200 can use any appropriate process to compute the difference images 216. For instance, the motion detection engine 200 can compute, for each of the second frames 206b-c, the difference between the corresponding down-sampled Y sub-frame and the down-sampled Y sub-frame for the first image t 206a. The difference can be an absolute difference, e.g., without negative values.

The motion detection engine 200 can generate a difference image combination 218 using the difference images 216. The difference image combination can be a matrix of vectors. For example, the motion detection engine 200 can concatenate the difference images 216 that are each 128x128 to generate the difference image combination. When there are three difference images, the difference image combination can be a matrix with a size of 3x128x128.

The motion detection engine 200 generates input data 220 for the deep motion detector 204 using down-sampled color image data 210 and the difference image combination 218. For instance, the motion detection engine 200 can concatenate the down-sampled color image data 210 and the difference image combination 218 to generate the input data 220.

The input data 220, and the other matrices and vectors described in this specification, can have any appropriate size. For instance, when the downsampled color images and the difference image combination have two dimensions that are both 128x128, the input data 220 can similarly have two dimensions that are 128x128. In some examples, the third dimension of the input data 220 can be six, e.g., when the color image and the difference image combination have third dimensions that are both three.

In some implementations, the motion detection engine 200 might not generate the difference image combination 218. For instance, the motion detection engine 200 can generate the input data 220 from the down-sampled color image data 210 and the difference images 216 without separately generating the difference image combination 218.

The deep motion detector 204 processes the input 220 to generate output 248. The output 248 indicates whether motion was likely detected given the processed frames 206a-d. For instance, the output 248 can be a binary value that indicates whether the deep motion detector 204 determined that the first frame t 206a likely depicted an object in motion, e.g., given the second frames 206b-d. In some examples, the output 248 can be a decimal value, e.g., between zero and one inclusive, that indicates the likelihood that the first frame t 206a depicts motion. The output 248 can be a vector that includes one value for each of multiple types of objects of interest, e.g., the types for which the deep motion detector was trained. When the deep motion detector is trained to detect people, animals, and vehicles, the output can be a vector with a length of four, one value for each of the object types and one value for no motion of interest.

The deep motion detector 204 can have any appropriate type of structure. For instance, the deep motion detector 204 can have one or more initial layers, one or more intermediate layers 232 and one or more final layers. In some instances, at least some of the data processed by the deep motion detector 204 can be processed through separate pathways such that not all input data is processed in the same way.

For example, the deep motion detector 204 can provide the input data 220, that includes both down-sampled color image data 210 and difference images 216 data to one or more convolutional layers 222. The convolutional layers 222 can accept 3x3 input with a stride of one. The number of inputs can be between 3 to 16, inclusive.

The deep motion detector 204 can provide the output of the convolutional layers 222 to one or more downsampling layers 224. The one or more downsampling layers 224, e.g., a downsampling block, can receive input with a dimension of 16x128x128 and generate output with a dimension of 32x64x64. The downsampling block can be implemented in any appropriate manner, e.g., with one or more max pooling layers, one or more convolutional layers, and a concatenation block. The concatenation block can concatenate outputs of the other layers to generate a final output for the downsampling block.

The deep motion detector 204 can extract the difference images 226, e.g., the difference images 216, from the input data 220. The deep motion detector 204 can provide the difference images 226 to a spatial attention module 228 (“SAM”). The spatial attention module 228 can be implemented in any appropriate manner. For instance, the spatial attention module 228 can provide the difference images 226 as input, separately, to one or more max pooling layers and one or more average pooling layers. The spatial attention module 228 can provide the output from both sets of those layers to a concatenation block that concatenates the first output data. One or more convolutional layers can receive that first output data to generate second output. The spatial attention module 228 can process the second output with one or more hard sigmoid layers to generate a final output.

A combination module 230 combines the outputs from the one or more downsampling layers 224 and the SAM 228. The combination module 230 can combine the outputs in any appropriate manner. For instance, the combination module can multiply, add, subtract, divide, concatenate, or a combination of these, the outputs from the one or more downsampling layers 224 and the SAM 228.

One or more residual layers 234 receive the output from the combination module 230. The one or more residual layers 234 generate an output using any appropriate process, layers, or both. For instance, the one or more residual layers 234 can implement a residual block that receives input, provides that input for processing by one or more convolutional layers, e.g., three convolutional layers, and combines the output from the one or more convolutional layers with the input using any appropriate process. The combination can be addition, subtraction, multiplication, division, concatenation, or any combination of these.

The one or more residual layers 234 can be part of the intermediate layers 232 in the deep motion detector 204. The intermediate layers 232 can include multiple processing pipelines that are combined with a second combination module 240, e.g., similar to the combination module 230. The first processing pipeline can include the one or more residual layers 234 and one or more second downsampling layers 236. The one or more second downsampling layers 236 can be implemented similarly to the one or more downsampling layers 224, described previously. In some instances, the one or more second downsampling layers 236 can receive input with dimensions of 32x64x64 and down-sample to 64x32x32. The second processing pipeline can include a second SAM 238. The second SAM 238 receives the difference images 226 as input, e.g., and does not receive as input data that has been generated by another portion of the deep motion detector 204.

The second combination module 240 can generate output using data from the one or more second downsampling layers 236 and the second SAM 238. The second combination module 240 can provide its output to one or more residual layers. The one or more residual layers can be another layer in the intermediate layers 232, e.g., repeating the pattern of residual layers, downsampling layers, SAM and combination module. When the deep motion detector includes two instances of the intermediate layers 232, the latter instance of the intermediate layers 232 can include one or more third downsampling layers. The one or more third downsampling layers can down-sample input from 64x32x32 to 128x16x16.

The one or more residual layers can have dimensions that align with the output of the prior one or more downsampling layers. For instance, when the one or more downsampling layers 224 generate output with dimensions of 32x64x64, the one or more residual layers 234 can have the same dimensions, e.g., for its input and output.

In some examples, the one or more residual layers that receive data from the combination module in the intermediate layers 232 can include one or more final residual layers 242 in the final layers of the deep motion detector 204. The one or more final residual layers 242 can have the same dimensions, for both input and output, as the output generated by the one or more downsampling layers from the last intermediate layers 232. For instance, when the final output is 128x16x16, the input and output processed by the one or more final residual layers 242 can have this same dimension.

The final layers of the deep motion detector 204 generate the final output 248. For instance, one or more global average pooling layers 244 receive, as input, output from the one or more final residual layers 244. The one or more global average pooling layers 244 can receive input with dimensions 128x16x16 and generate output with dimensions 128x1x1. One or more fully connected layers 246 receive the output from the one or more global average pooling layers 244 and generate corresponding output. For an input with dimension 128, the one or more fully connected layers 246 can generate an output with four values, e.g., one for each type of motion. This can include one value for motion for people, one value for motion for animals, one value for motion for vehicles, and one value for no motion or motion that is not of interest. Motion that is not of interest can include any other types of motion than those for the other motion types.

Although the structure of some layers, blocks, and modules is described, other appropriate types of structures can also be used. In some instances, other types of layers, blocks, and modules for which corresponding structure was not described can have the structure or structure similar to that which was described.

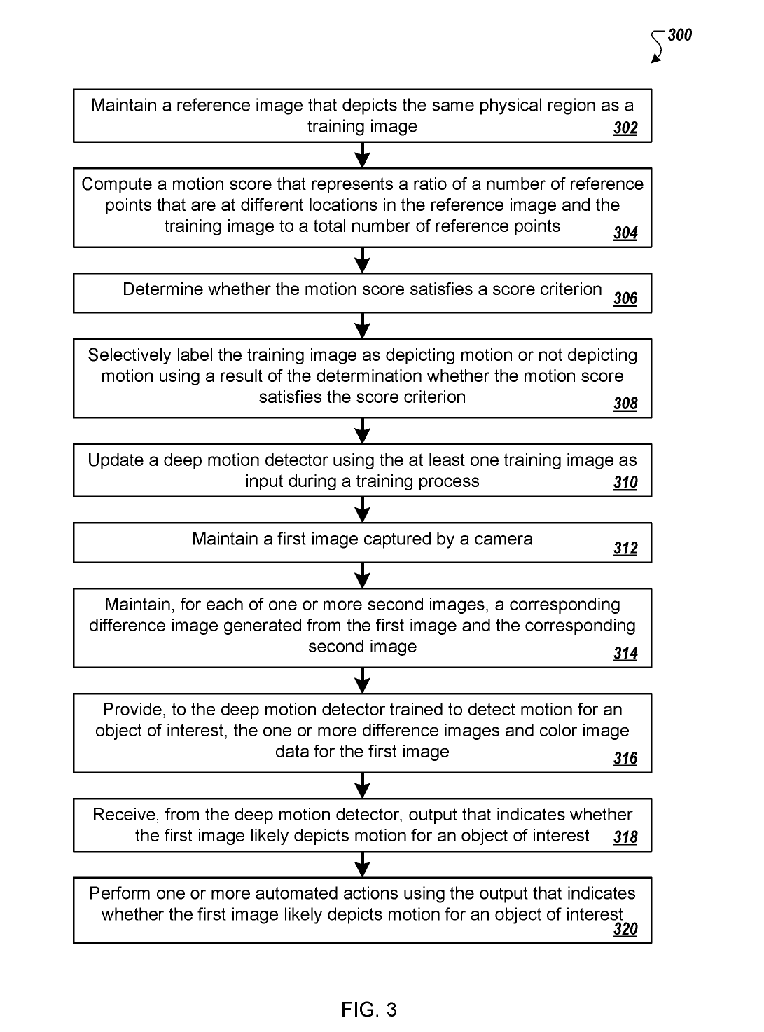

FIG. 3 is a flow diagram of a process 300 for using a motion detector. For example, the process 300 can be used by the training system 118, the camera 102, e.g., as a system, or a combination of both, from the environment 100. Some example systems can include a backend system, e.g., a cloud computing system.

A training system maintains a reference image that depicts the same physical region as a training image (302). For instance, the training image can be a frame t for analysis, e.g., the first frame described above. A reference image can be an image used to analyze whether the reference image likely depicts motion. For example, the reference images can include the one or more second frames, e.g., captured at times t+1, t+2, and t+3 as described above. The images can be any appropriate type of image, have any appropriate type of encoding, e.g., color model, or both. Some examples of color models include RGB and YUV.

The training system computes a motion score that represents a ratio of a number of reference points that are at different locations in the reference image and the training image to a total number of reference points (304). For instance, the training system can detect, for at least some of the images, one or more objects of interest. The objects of interest can be people, animals, vehicles, or any combination of these. In some instances, the objects of interest might include subcategories of objects, e.g., some but not all types of animals.

The training system can detect, for the objects of interest, reference points for the corresponding object that are depicted in a corresponding image. A reference point can be a point on the object, e.g., the boundary of the object, that defines part of the shape of the object.

The training system can detect, using the training image and a single reference image, points in the training image and the reference image that likely correspond to the same point in the object. The training system can compute a distance between the points in the training image and the reference image. The training system can use the distances between the points for the objects depicted in a training image to compute the corresponding motion score. In some implementations, the training system can compute the motion score using data for all objects depicted in the corresponding training image.

The training system determines whether the motion score satisfies a score criterion (306). The motion score can satisfy the score criterion in any appropriate manner. For instance, the motion score can satisfy the score criterion when the motion score is less than the score criterion, e.g., when both values are numbers. In these instances, the motion score would not satisfy the score criterion when the motion score is greater than or equal to the score criterion. In some examples, the motion score can satisfy the score criterion when the motion score is equal to, greater than, or either, the score criterion.

The training system selectively labels the training image as depicting motion or not depicting motion using a result of the determination whether the motion score satisfies the score criterion (308). For example, in response to determining that the motion score satisfies the score criterion, the training system can label the training image as likely depicting motion. In response to determining that the motion score does not satisfy the score criterion, the training system can label the training image as not likely depicting motion.

In some instances, the training system labels the images as likely depicting motion, or not, when the motion is for an object of interest and labels the images as not depicting motion even though the image might depict motion of a non-object of interest. For instance, when objects of interest include people, animals, and vehicles, the training system can label an image as not depicting motion, or not depicting motion of interest, when the image that depicts movement of a branch. The training system can label an image as depicting motion when the image depicts movement of a person, animal, or vehicle.

The training system updates a deep motion detector using the at least one training image as input during a training process (310). The training system can use any appropriate training process to train the deep motion detector using the training images.

When the training system determines to stop training the deep motion detector, the training system can store, in memory, the deep motion detector, e.g., weights for the deep motion detector, code for the deep motion detector implemented as part of a motion detection engine, or both. The training system can provide the deep motion detector, e.g., the weights, to another system. The other system can be a camera that uses the deep motion detector, e.g., as part of the motion detection engine, to detect motion.

A system maintains a first image captured by a camera (312). For instance, the camera, e.g., an image sensor included in the camera, can capture the first image. The system, e.g., the camera, can store the first image in memory to maintain the first image. The memory can be a volatile or non-volatile memory, or any other appropriate type of memory.

The system maintains, for each of one or more second images, a corresponding difference image generated from the first image and the corresponding second image (314). For example, the camera can capture the one or more second images similar to the capture of the first image. In some instances, the second images can include multiple, e.g., two or more, images. The system can maintain the one or more second images, e.g., in memory. The system can compute the one or more difference images, each for a corresponding one of the second images. The difference images can be a difference between the luminance channels in the first image and the corresponding second image. In some instances, the difference image can be of a downsampled version of at least some of the images.

The system provides, to the deep motion detector trained to detect motion for an object of interest, the one or more difference images and color image data for the first image (316). Provision of the input that includes the one or more difference images and the color image data can cause the deep motion detector to generate output. The output can indicate whether the first image likely depicts motion. The output can include any appropriate type, number, or both, of values, e.g., as described elsewhere in this specification.

In some examples, the system can provide the deep motion detector color image data for multiple images, e.g., the first image and at least one of the second images or a third image.

The system receives, from the deep motion detector, output that indicates whether the first image likely depicts motion for an object of interest (318). For example, in response to providing the input, the system can receive the output. The system can use the output to determine whether the output indicates that the image likely depicts motion for an object of interest, e.g., a type of object for which the deep motion detector was trained during operation 310. The output can be any appropriate type, e.g., a single value or multiple values such as a vector.

The system performs one or more automated actions using the output that indicates whether the first image likely depicts motion for an object of interest (320). The actions can be any appropriate type of actions. The actions can include transmitting, to another system or engine, a message that indicates that motion of an object of interest was detected. The transmission can occur in response to determining that the output indicates that the image likely depicts motion for an object of interest. The message can include or otherwise identify data for the first image, e.g., can include the first image or a down-sampled version of the first image. In some examples, the message can include a video stream that includes one or more images captured by the camera subsequent to the first image, e.g., a video stream of the event for which the motion was detected.

In some implementations, the other engine can include a downstream engine implemented on the same system that includes the deep motion detector. For instance, the system can implement an object detector that is more robust and performs a different type of analysis on data for the first image. The downstream engine can consume more energy, generate more thermal heat, or both, than the deep motion detector. By using the deep motion detector to detect events, objects, or both, of interest, the system can reduce resource usage and cause the downstream engine to analyze only a subset of image data, e.g., that image data determined by the deep motion detector to most likely depict objects of interest. The downstream engine can determine whether an object is a particular object and an action for a monitoring system to perform given the particular object detected.

The actions can include removing at least one of the analyzed images from motion analysis for the first image. This can occur in response to determining that the output indicates that the first image likely does not depict motion for an object of interest. For instance, the system can delete the image, determine that the image should not be used for further motion detection analysis, e.g., but might be used for other analysis, or any combination of both. The image can be any appropriate image, e.g., the first image or any one of the one or more second images. For instance, upon determining that the first image does not likely depict motion for an object of interest, the system can store the first image in a long-term memory and stop processing the image with the deep motion detector. The first image can later be used by another system or process for presentation of a video stream, analysis, or both.

When the system analyzes the first image and second, subsequent images, and the system removes the first image from motion analysis, the system might not use the first image for motion analysis of other subsequent images. When the system analyzes the first image and second, prior images, the system would not use the first image for motion analysis of the first image but can use the first image for motion analysis of a subsequent image, e.g., a third subsequent image.

In some instances, when the system removes an image from motion analysis, the system might maintain the image in memory for other types of analysis. For instance, the system might provide the image to another processing engine, e.g., an object detector, or an object tracking engine. The system can maintain the image for other actions, e.g., to generate a video for an invent, including some images in the video before and after the event.

The order of operations in the process 300 described above is illustrative only, and the use of the deep motion detector can be performed in different orders. For example, the process 300 can include receiving output from the deep motion detector, e.g., operation 318, before a subsequent training of the deep motion detector, e.g., operation 310.

In some implementations, the process 300 can include additional operations, fewer operations, or some of the operations can be divided into multiple operations. For example, the process 300 might include one or more of operations 302 through 310 without the other operations. The process 300 might include one or more of operations 312 through 320 without the other operations.

In some implementations, some of the process 300 is performed on a backend system, e.g., other than an edge device such as a camera. This can include operations 312 through 320. In these implementations, the backend system can receive the first image captured by the camera, e.g., as part of operation 312. For instance, when a panel event is triggered for a property, the backend system can receive video, e.g., video clips from one or more video devices at the property, e.g., cameras. The video devices can start recording, transmission of the video clips to the backend system, or both, in response to receipt of an instruction given the triggering of the panel event.

The backend system can execute one or more of the operations, maintain the deep motion detector, or both. For instance, the backend system can provide images from the video clips to the deep motion detector that is executing on the backend system. The backend system can use the deep motion detector to look for true motion, e.g., motion caused by an event for which the deep motion detector is trained and that is not likely a false alarm. For images from the video clip for which true motion is detected, the backend system can send those images to a classifier. The classifier can be implemented on the same backend system as the deep motion detector or another backend system.

The classifier can perform any appropriate operations on the image. For instance, the classifier can determine whether the image depicts a person. If so, the system that implements the classifier can transmit, in a message, the image to a central alarm system. The message can indicate that the image is for high priority analysis, e.g., review.

In some implementations, by implementing a deep motion detector on a backend system, e.g., instead of or in addition to implementation of a deep motion detector on a camera, the cloud system can process a video clip faster than other systems. In some implementations, by implementing a deep motion detector on a backend system, the cloud system can reduce computational resources for processing images, e.g., images from video clips that do not depict true motion.

In this specification, the term likely is used to mean that there is a likelihood that something might occur and that likelihood satisfies a likelihood threshold. For instance, when determining that an object is likely depicted in an image, an image likely depicts motion, or both, a system would determine a likelihood that the object is depicted in the image, a likelihood that the object is moving, or both. The system would then determine whether the likelihood satisfies, e.g., is greater than or equal to, a likelihood threshold by comparing the two values. If so, the system determines that the object is likely depicted in the image, the object is likely moving, or both. If not, the system determines that the object is not likely depicted in the image, is not likely moving, or both. In instances in which one likelihood satisfies the threshold and the other does not, the system can determine that there is likely an object depicted in an image while the object is not likely moving. Sometimes a system can determine whether an object is likely moving without positively determining that there is likely an object depicted in an image. This can occur when the system detects motion which can implicitly indicate that there is likely an object that caused the motion.

In this specification the term “engine”, module, or detector (referred to as an engine in the following sentences) is used broadly to refer to a software-based system, subsystem, or process that is programmed to perform one or more specific functions. Generally, an engine will be implemented as one or more software modules or components, e.g., implemented in code, installed on one or more computers in one or more locations. In some instances, one or more computers will be dedicated to a particular engine. In some instances, multiple engines can be installed and running on the same computer or computers.

In this specification, the term “database” is used broadly to refer to any collection of data: the data does not need to be structured in any particular way, or structured at all, and it can be stored on storage devices in one or more locations. A database can be implemented on any appropriate type of memory.

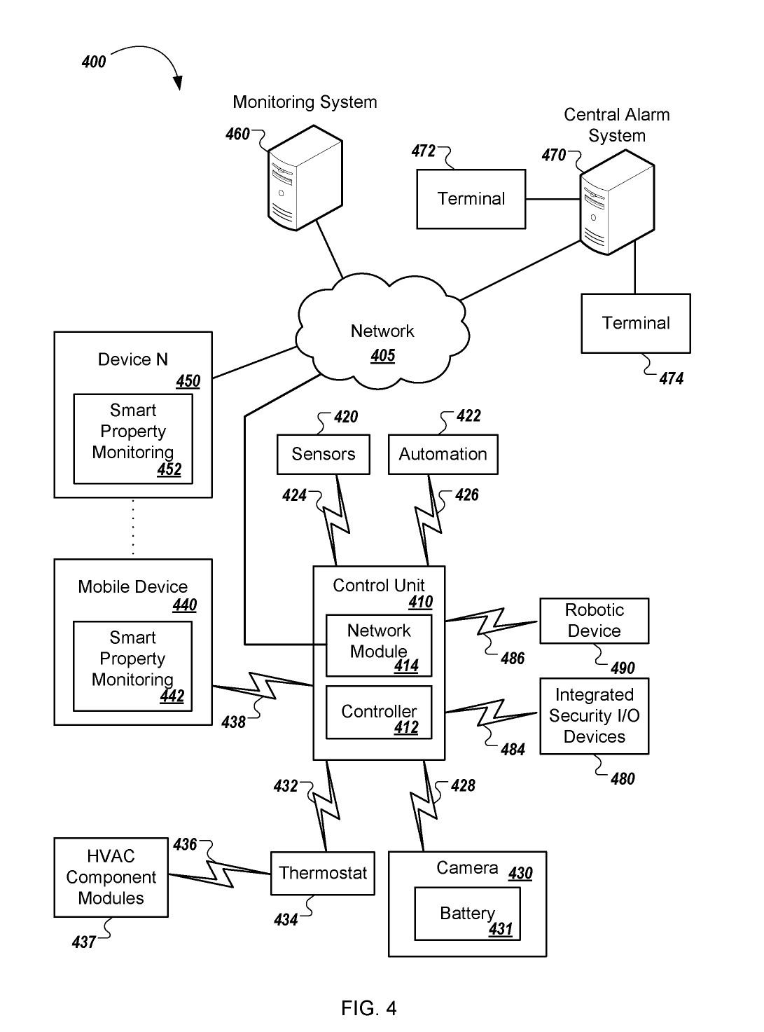

FIG. 4 is a diagram illustrating an example of an environment 400, e.g., for monitoring a property. The property can be any appropriate type of property, such as a home, a business, or a combination of both. The environment 400 includes a network 405, a control unit 410, one or more devices 440 and 450, a monitoring system 460, a central alarm system 470, or a combination of two or more of these. In some examples, the network 405 facilitates communications between two or more of the control unit 410, the one or more devices 440 and 450, the monitoring system 460, and the central alarm system 470.

The network 405 is configured to enable exchange of electronic communications between devices connected to the network 405. For example, the network 405 can be configured to enable exchange of electronic communications between the control unit 410, the one or more devices 440 and 450, the monitoring system 460, and the central alarm system 470. The network 405 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 405 can include multiple networks or subnetworks, each of which can include, for example, a wired or wireless data pathway. The network 405 can include a circuit-switched network, a packet-switched data network, or any other network able to carry electronic communications (e.g., data or voice communications). For example, the network 405 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 405 can include one or more networks that include wireless data channels and wireless voice channels. The network 405 can be a broadband network.

The control unit 410 includes a controller 412 and a network module 414. The controller 412 is configured to control a control unit monitoring system, e.g., a control unit system, that includes the control unit 410. In some examples, the controller 412 can include one or more processors or other control circuitry configured to execute instructions of a program that controls operation of a control unit system. In these examples, the controller 412 can be configured to receive input from sensors, or other devices included in the control unit system and control operations of devices at the property, e.g., speakers, displays, lights, doors, other appropriate devices, or a combination of these. For example, the controller 412 can be configured to control operation of the network module 414 included in the control unit 410.

The network module 414 is a communication device configured to exchange communications over the network 405. The network module 414 can be a wireless communication module configured to exchange wireless, wired, or a combination of both, communications over the network 405. For example, the network module 414 can be a wireless communication device configured to exchange communications over a wireless data channel and a wireless voice channel. In some examples, the network module 414 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 414 can be a wired communication module configured to exchange communications over the network 405 using a wired connection. For instance, the network module 414 can be a modem, a network interface card, or another type of network interface device. The network module 414 can be an Ethernet network card configured to enable the control unit 410 to communicate over a local area network, the Internet, or a combination of both. The network module 414 can be a voice band modem configured to enable the alarm panel to communicate over the telephone lines of Plain Old Telephone Systems (“POTS”).

The control unit system that includes the control unit 410 can include one or more sensors 420. For example, the environment 400 can include multiple sensors 420. The sensors 420 can include a lock sensor, a contact sensor, a motion sensor, a camera (e.g., a camera 430), a flow meter, any other type of sensor included in a control unit system, or a combination of two or more of these. The sensors 420 can include an environmental sensor, such as a temperature sensor, a water sensor, a rain sensor, a wind sensor, a light sensor, a smoke detector, a carbon monoxide detector, or an air quality sensor, to name a few additional examples. The sensors 420 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 420 can include a radio- frequency identification (“RFID”) sensor that identifies a particular article that includes a pre-assigned RFID tag.

The control unit 410 can communicate with a module 422 and a camera 430 to perform monitoring. The module 422 is connected to one or more devices that enable property automation, e.g., home or business automation. For instance, the module 422 can connect to, and be configured to control operation of, one or more lighting systems. The module 422 can connect to, and be configured to control operation of, one or more electronic locks, e.g., control Z-Wave locks using wireless communications in the Z-Wave protocol. In some examples, the module 422 can connect to, and be configured to control operation of, one or more appliances. The module 422 can include multiple sub-modules that are each specific to a type of device being controlled in an automated manner. The module 422 can control the one or more devices using commands received from the control unit 410. For instance, the module 422 can receive a command from the control unit 410, which command was sent using data captured by the camera 430 that depicts an area. In response, the module 422 can cause a lighting system to illuminate an area to provide better lighting in the area, and a higher likelihood that the camera 430 can capture a subsequent image of the area that depicts more accurate data of the area.

The camera 430 can be an image camera or other type of optical sensing device configured to capture one or more images. For instance, the camera 430 can be configured to capture images of an area within a property monitored by the control unit 410. The camera 430 can be configured to capture single, static images of the area; video of the area, e.g., a sequence of images; or a combination of both. The sequence of images can be a sequence of frames, e.g., when the video is compressed using a video codec. The image captured by the camera can be any appropriate type of image, e.g., a frame. The camera 430 can be controlled using commands received from the control unit 410 or another device in the property monitoring system, e.g., a device 450.

The camera 430 can be triggered using any appropriate techniques, can capture images continuously, or a combination of both. For instance, a Passive Infra-Red (“PIR”) motion sensor can be built into the camera 430 and used to trigger the camera 430 to capture one or more images when motion is detected. The camera 430 can include a microwave motion sensor built into the camera which is used to trigger the camera 430 to capture one or more images when motion is detected. The camera 430 can have a “normally open” or “normally closed” digital input that can trigger capture of one or more images when external sensors detect motion or other events. The external sensors can include another sensor from the sensors 420, PIR, or door or window sensors, to name a few examples. In some implementations, the camera 430 receives a command to capture an image, e.g., when external devices detect motion or another potential alarm event or in response to a request from a device. The camera 430 can receive the command from the controller 412, directly from one of the sensors 420, or a combination of both.

In some examples, the camera 430 triggers integrated or external illuminators to improve image quality when the scene is dark. Some examples of illuminators can include Infra-Red, Z-wave controlled “white” lights, lights controlled by the module 422, or a combination of these. An integrated or separate light sensor can be used to determine if illumination is desired and can result in increased image quality.

The camera 430 can be programmed with any combination of time schedule, day schedule, system “arming state”, other variables, or a combination of these, to determine whether images should be captured when one or more triggers occur. The camera 430 can enter a low-power mode when not capturing images. In this case, the camera 430 can wake periodically to check for inbound messages from the controller 412 or another device. The camera 430 can be powered by internal, replaceable batteries, e.g., if located remotely from the control unit 410. The camera 430 can employ a small solar cell to recharge the battery when light is available. The camera 430 can be powered by a wired power supply, e.g., the controller’s 412 power supply if the camera 430 is co-located with the controller 412.

In some implementations, the camera 430 communicates directly with the monitoring system 460 over the network 405. In these implementations, image data captured by the camera 430 need not pass through the control unit 410. The camera 430 can receive commands related to operation from the monitoring system 460, provide images to the monitoring system 460, or a combination of both.

The environment 400 can include one or more thermostats 434, e.g., to perform dynamic environmental control at the property. The thermostat 434 is configured to monitor temperature of the property, energy consumption of a heating, ventilation, and air conditioning (“HVAC”) system associated with the thermostat 434, or both. In some examples, the thermostat 434 is configured to provide control of environmental (e.g., temperature) settings. In some implementations, the thermostat 434 can additionally or alternatively receive data relating to activity at a property; environmental data at a property, e.g., at various locations indoors or outdoors or both at the property; or a combination of both. The thermostat 434 can measure or estimate energy consumption of the HVAC system associated with the thermostat. The thermostat 434 can estimate energy consumption, for example, using data that indicates usage of one or more components of the HVAC system associated with the thermostat 434. The thermostat 434 can communicate various data, e.g., temperature, energy, or both, with the control unit 410. In some examples, the thermostat 434 can control the environment, e.g., temperature, settings in response to commands received from the control unit 410.

In some implementations, the thermostat 434 is a dynamically programmable thermostat and can be integrated with the control unit 410. For example, the dynamically programmable thermostat 434 can include the control unit 410, e.g., as an internal component to the dynamically programmable thermostat 434. In some examples, the control unit 410 can be a gateway device that communicates with the dynamically programmable thermostat 434. In some implementations, the thermostat 434 is controlled via one or more modules 422.

The environment 400 can include the HVAC system or otherwise be connected to the HVAC system. For instance, the environment 400 can include one or more HVAC modules 437. The HVAC modules 437 can be connected to one or more components of the HVAC system associated with a property. A module 437 can be configured to capture sensor data from, control operation of, or both, corresponding components of the HVAC system. In some implementations, the module 437 is configured to monitor energy consumption of an HVAC system component, for example, by directly measuring the energy consumption of the HVAC system components or by estimating the energy usage of the one or more HVAC system components by detecting usage of components of the HVAC system. The module 437 can communicate energy monitoring information, the state of the HVAC system components, or both, to the thermostat 434. The module 437 can control the one or more components of the HVAC system in response to receipt of commands received from the thermostat 434.

In some examples, the environment 400 includes one or more robotic devices 490. The robotic devices 490 can be any type of robots that are capable of moving, such as an aerial drone, a land-based robot, or a combination of both. The robotic devices 490 can take actions, such as capture sensor data or other actions that assist in security monitoring, property automation, or a combination of both. For example, the robotic devices 490 can include robots capable of moving throughout a property using automated navigation control technology, user input control provided by a user, or a combination of both. The robotic devices 490 can fly, roll, walk, or otherwise move about the property. The robotic devices 490 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 490 can be robotic devices 490 that are intended for other purposes and merely associated with the environment 400 for use in appropriate circumstances. For instance, a robotic vacuum cleaner device can be associated with the environment 400 as one of the robotic devices 490 and can be controlled to take action responsive to monitoring system events.

In some examples, the robotic devices 490 automatically navigate within a property. In these examples, the robotic devices 490 include sensors and control processors that guide movement of the robotic devices 490 within the property. For instance, the robotic devices 490 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 490 can include control processors that process output from the various sensors and control the robotic devices 490 to move along a path that reaches the desired destination, avoids obstacles, or a combination of both. In this regard, the control processors detect walls or other obstacles in the property and guide movement of the robotic devices 490 in a manner that avoids the walls and other obstacles.

In some implementations, the robotic devices 490 can store data that describes attributes of the property. For instance, the robotic devices 490 can store a floorplan, a three-dimensional model of the property, or a combination of both, that enable the robotic devices 490 to navigate the property. During initial configuration, the robotic devices 490 can receive the data describing attributes of the property, determine a frame of reference to the data (e.g., a property or reference location in the property), and navigate the property using the frame of reference and the data describing attributes of the property. In some examples, initial configuration of the robotic devices 490 can include learning one or more navigation patterns in which a user provides input to control the robotic devices 490 to perform a specific navigation action (e.g., fly to an upstairs bedroom and spin around while capturing video and then return to a property charging base). In this regard, the robotic devices 490 can learn and store the navigation patterns such that the robotic devices 490 can automatically repeat the specific navigation actions upon a later request.

In some examples, the robotic devices 490 can include data capture devices. In these examples, the robotic devices 490 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 490 to take and store a biometric sample that can be used to identify the person (e.g., a biometric sample with DNA that can be used for DNA testing).

In some implementations, the robotic devices 490 can include output devices. In these implementations, the robotic devices 490 can include one or more displays, one or more speakers, any other type of output devices that allow the robotic devices 490 to communicate information, e.g., to a nearby user or another type of person, or a combination of these.

The robotic devices 490 can include a communication module that enables the robotic devices 490 to communicate with the control unit 410, each other, other devices, or a combination of these. The communication module can be a wireless communication module that allows the robotic devices 490 to communicate wirelessly. For instance, the communication module can be a Wi-Fi module that enables the robotic devices 490 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 490 to communicate with other devices, e.g., in or off the property. In some implementations, the robotic devices 490 can communicate with each other or with other devices of the environment 400 through the network 405.

The robotic devices 490 can include processor and storage capabilities. The robotic devices 490 can include any one or more suitable processing devices that enable the robotic devices 490 to execute instructions, operate applications, perform the actions described throughout this specification, or a combination of these. In some examples, the robotic devices 490 can include solid-state electronic storage that enables the robotic devices 490 to store applications, configuration data, collected sensor data, any other type of information available to the robotic devices 490, or a combination of two or more of these.

The robotic devices 490 can process captured data locally, provide captured data to one or more other devices for processing, e.g., the control unit 410 or the monitoring system 460, or a combination of both. For instance, the robotic device 490 can provide the images to the control unit 410 for processing. In some examples, the robotic device 490 can process the images to determine an identification of the items.

One or more of the robotic devices 490 can be associated with one or more charging stations. The charging stations can be located at a predefined home base or reference location in the property. The robotic devices 490 can be configured to navigate to one of the charging stations after completion of one or more tasks needed to be performed, e.g., for the environment 400. For instance, after completion of a monitoring operation or upon instruction by the control unit 410, a robotic device 490 can be configured to automatically fly to and connect with, e.g., land on, one of the charging stations. In this regard, a robotic device 490 can automatically recharge one or more batteries included in the robotic device 490 so that the robotic device 490 is less likely to need recharging when the environment 400 requires use of the robotic device 490, e.g., absent other concerns for the robotic device 490.

The charging stations can be contact-based charging stations, wireless charging stations, or a combination of both. For contact-based charging stations, the robotic devices 490 can have readily accessible points of contact to which a robotic device 490 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 490 can include a cover that opens to expose the electronic contact when the robotic device is charging and closes to cover and insulate the electronic contact when the robotic device 490 is in operation.

For wireless charging stations, the robotic devices 490 can charge through a wireless exchange of power. In these instances, a robotic device 490 needs only position itself closely enough to a wireless charging station for the wireless exchange of power to occur. In this regard, the positioning needed to land at a predefined home base or reference location in the property can be less precise than with a contact-based charging station. Based on the robotic devices 490 landing at a wireless charging station, the wireless charging station can output a wireless signal that the robotic device 490 receives and converts to a power signal that charges a battery maintained on the robotic device 490. As described in this specification, a robotic device 490 landing or coupling with a charging station can include a robotic device 490 positioning itself within a threshold distance of a wireless charging station such that the robotic device 490 is able to charge its battery.

In some implementations, one or more of the robotic devices 490 has an assigned charging station. In these implementations, the number of robotic devices 490 can equal the number of charging stations. In these implementations, the robotic devices 490 can always navigate to the specific charging station assigned to that robotic device 490. For instance, a first robotic device can always use a first charging station and a second robotic device can always use a second charging station.

In some examples, the robotic devices 490 can share charging stations. For instance, the robotic devices 490 can use one or more community charging stations that are capable of charging multiple robotic devices 490, e.g., substantially concurrently or separately or a combination of both at different times. The community charging station can be configured to charge multiple robotic devices 490 at substantially the same time, e.g., the community charging station can begin charging a first robotic device and then, while charging the first robotic device, begin charging a second robotic device five minutes later. The community charging station can be configured to charge multiple robotic devices 490 in serial such that the multiple robotic devices 490 take turns charging and, when fully charged, return to a predefined home base or reference location or another location in the property that is not associated with a charging station. The number of community charging stations can be less than the number of robotic devices 490.

In some instances, the charging stations might not be assigned to specific robotic devices 490 and can be capable of charging any of the robotic devices 490. In this regard, the robotic devices 490 can use any suitable, unoccupied charging station when not in use, e.g., when not performing an operation for the environment 400. For instance, when one of the robotic devices 490 has completed an operation or is in need of battery charge, the control unit 410 can reference a stored table of the occupancy status of each charging station and instructs the robotic device to navigate to the nearest charging station that has at least one unoccupied charger.

The environment 400 can include one or more integrated security devices 480. The one or more integrated security devices can include any type of device used to provide alerts based on received sensor data. For instance, the one or more control units 410 can provide one or more alerts to the one or more integrated security input/output devices 480. In some examples, the one or more control units 410 can receive sensor data from the sensors 420 and determine whether to provide an alert, or a message to cause presentation of an alert, to the one or more integrated security input/output devices 480.

The sensors 420, the module 422, the camera 430, the thermostat 434, the module 437, the integrated security devices 480, and the robotic devices 490, can communicate with the controller 412 over communication links 424, 426, 428, 432, 436, 438, 484, and 486. The communication links 424, 426, 428, 432, 436, 438, 484, and 486 can be a wired or wireless data pathway configured to transmit signals between any combination of the sensors 420, the module 422, the camera 430, the thermostat 434, the module 437, the integrated security devices 480, the robotic devices 490, or the controller 412. The sensors 420, the module 422, the camera 430, the thermostat 434, the module 437, the integrated security devices 480, and the robotic devices 490, can continuously transmit sensed values to the controller 412, periodically transmit sensed values to the controller 412, or transmit sensed values to the controller 412 in response to a change in a sensed value, a request, or both. In some implementations, the robotic devices 490 can communicate with the monitoring system 460 over network 405. The robotic devices 490 can connect and communicate with the monitoring system 460 using a Wi-Fi or a cellular connection or any other appropriate type of connection.

The communication links 424, 426, 428, 432, 436, 438, 484, and 486 can include any appropriate type of network, such as a local network. The sensors 420, the module 422, the camera 430, the thermostat 434, the robotic devices 490 and the integrated security devices 480, and the controller 412 can exchange data and commands over the network.

The monitoring system 460 can include one or more electronic devices, e.g., one or more computers. The monitoring system 460 is configured to provide monitoring services by exchanging electronic communications with the control unit 410, the one or more devices 440 and 450, the central alarm system 470, or a combination of these, over the network 405. For example, the monitoring system 460 can be configured to monitor events (e.g., alarm events) generated by the control unit 410. In these examples, the monitoring system 460 can exchange electronic communications with the network module 414 included in the control unit 410 to receive information regarding events (e.g., alerts) detected by the control unit 410. The monitoring system 460 can receive information regarding events (e.g., alerts) from the one or more devices 440 and 450.

In some implementations, the monitoring system 460 might be configured to provide one or more services other than monitoring services. In these implementations, the monitoring system 460 might perform one or more operations described in this specification without providing any monitoring services, e.g., the monitoring system 460 might not be a monitoring system as described in the example shown in FIG. 4.

In some examples, the monitoring system 460 can route alert data received from the network module 414 or the one or more devices 440 and 450 to the central alarm system 470. For example, the monitoring system 460 can transmit the alert data to the central alarm system 470 over the network 405.

The monitoring system 460 can store sensor and image data received from the environment 400 and perform analysis of sensor and image data received from the environment 400. Based on the analysis, the monitoring system 460 can communicate with and control aspects of the control unit 410 or the one or more devices 440 and 450.

The monitoring system 460 can provide various monitoring services to the environment 400. For example, the monitoring system 460 can analyze the sensor, image, and other data to determine an activity pattern of a person of the property monitored by the environment 400. In some implementations, the monitoring system 460 can analyze the data for alarm conditions or can determine and perform actions at the property by issuing commands to one or more components of the environment 400, possibly through the control unit 410.

The central alarm system 470 is an electronic device, or multiple electronic devices, configured to provide alarm monitoring service by exchanging communications with the control unit 410, the one or more mobile devices 440 and 450, the monitoring system 460, or a combination of these, over the network 405. For example, the central alarm system 470 can be configured to monitor alerting events generated by the control unit 410. In these examples, the central alarm system 470 can exchange communications with the network module 414 included in the control unit 410 to receive information regarding alerting events detected by the control unit 410. The central alarm system 470 can receive information regarding alerting events from the one or more mobile devices 440 and 450, the monitoring system 460, or both. In some implementations, the central alarm system 470 can be implemented, at least in part if not entirely, on the monitoring system 460. In these implementations, the monitoring system 460 can perform the operations described with reference to the central alarm system 470. One or both of the monitoring systems 460 or the central alarm system 470 can be implemented in the cloud.

The central alarm system 470 is connected to multiple terminals 472 and 474. The terminals 472 and 474 can be used by operators to process alerting events. For example, the central alarm system 470, e.g., as part of a first responder system, can route alerting data to the terminals 472 and 474 to enable an operator to process the alerting data. The terminals 472 and 474 can include general-purpose computers (e.g., desktop personal computers, workstations, or laptop computers) that are configured to receive alerting data from a computer in the central alarm system 470 and render a display of information using the alerting data.

For instance, the controller 412 can control the network module 414 to transmit, to the central alarm system 470, alerting data indicating that a sensor 420 detected motion from a motion sensor via the sensors 420. The central alarm system 470 can receive the alerting data and route the alerting data to the terminal 472 for processing by an operator associated with the terminal 472. The terminal 472 can render a display to the operator that includes information associated with the alerting event (e.g., the lock sensor data, the motion sensor data, the contact sensor data, etc.) and the operator can handle the alerting event based on the displayed information. In some implementations, the terminals 472 and 474 can be mobile devices or devices designed for a specific function. Although FIG. 4 illustrates two terminals for brevity, actual implementations can include more (and, perhaps, many more) terminals.

The one or more devices 440 and 450 are devices that can present content, e.g., host and display user interfaces, audio data, or both. For instance, the mobile device 440 is a mobile device that hosts or runs one or more native applications (e.g., the smart property application 442). The mobile device 440 can be a cellular phone or a non-cellular locally networked device with a display. The mobile device 440 can include a cell phone, a smart phone, a tablet PC, a personal digital assistant (“PDA”), or any other portable device configured to communicate over a network and present information. The mobile device 440 can perform functions unrelated to the monitoring system, such as placing personal telephone calls, playing music, playing video, displaying pictures, browsing the Internet, and maintaining an electronic calendar.

The mobile device 440 can include a smart property application 442. The smart property application 442 refers to a software/firmware program running on the corresponding mobile device that enables the user interface and features described throughout. The mobile device 440 can load or install the smart property application 442 using data received over a network or data received from local media. The smart property application 442 enables the mobile device 440 to receive and process image and sensor data from the monitoring system 460.

The device 450 can be a general-purpose computer (e.g., a desktop personal computer, a workstation, or a laptop computer) that is configured to communicate with the monitoring system 460, the control unit 410, or both, over the network 405. The device 450 can be configured to display a smart property user interface 452 that is generated by the device 450 or generated by the monitoring system 460. For example, the device 450 can be configured to display a user interface (e.g., a web page) generated using data provided by the monitoring system 460 that enables a user to perceive images captured by the camera 430, reports related to the monitoring system, or both. Although FIG. 4 illustrates two devices for brevity, actual implementations can include more (and, perhaps, many more) or fewer devices.

In some implementations, the one or more devices 440 and 450 communicate with and receive data from the control unit 410 using the communication link 438. For instance, the one or more devices 440 and 450 can communicate with the control unit 410 using various wireless protocols, or wired protocols such as Ethernet and USB, to connect the one or more devices 440 and 450 to the control unit 410, e.g., local security and automation equipment. The one or more devices 440 and 450 can use a local network, a wide area network, or a combination of both, to communicate with other components in the environment 400. The one or more devices 440 and 450 can connect locally to the sensors and other devices in the environment 400.

Although the one or more devices 440 and 450 are shown as communicating with the control unit 410, the one or more devices 440 and 450 can communicate directly with the sensors and other devices controlled by the control unit 410. In some implementations, the one or more devices 440 and 450 replace the control unit 410 and perform one or more of the functions of the control unit 410 for local monitoring and long range, offsite, or both, communication.

In some implementations, the one or more devices 440 and 450 receive monitoring system data captured by the control unit 410 through the network 405. The one or more devices 440 and 450 can receive the data from the control unit 410 through the network 405, the monitoring system 460 can relay data received from the control unit 410 to the one or more devices 440 and 450 through the network 405, or a combination of both. In this regard, the monitoring system 460 can facilitate communication between the one or more devices 440 and 450 and various other components in the environment 400.

In some implementations, the one or more devices 440 and 450 can be configured to switch whether the one or more devices 440 and 450 communicate with the control unit 410 directly (e.g., through communication link 438) or through the monitoring system 460 (e.g., through network 405) based on a location of the one or more devices 440 and 450. For instance, when the one or more devices 440 and 450 are located close to, e.g., within a threshold distance of, the control unit 410 and in range to communicate directly with the control unit 410, the one or more devices 440 and 450 use direct communication. When the one or more devices 440 and 450 are located far from, e.g., outside the threshold distance of, the control unit 410 and not in range to communicate directly with the control unit 410, the one or more devices 440 and 450 use communication through the monitoring system 460.

Although the one or more devices 440 and 450 are shown as being connected to the network 405, in some implementations, the one or more devices 440 and 450 are not connected to the network 405. In these implementations, the one or more devices 440 and 450 communicate directly with one or more of the monitoring system components and no network (e.g., Internet) connection or reliance on remote servers is needed.

In some implementations, the one or more devices 440 and 450 are used in conjunction with only local sensors and/or local devices in a house. In these implementations, the environment 400 includes the one or more devices 440 and 450, the sensors 420, the module 422, the camera 430, and the robotic devices 490. The one or more devices 440 and 450 receive data directly from the sensors 420, the module 422, the camera 430, the robotic devices 490, or a combination of these, and send data directly to the sensors 420, the module 422, the camera 430, the robotic devices 490, or a combination of these. The one or more devices 440 and 450 can provide the appropriate interface, processing, or both, to provide visual surveillance and reporting using data received from the various other components.

In some implementations, the environment 400 includes network 405 and the sensors 420, the module 422, the camera 430, the thermostat 434, and the robotic devices 490 are configured to communicate sensor and image data to the one or more devices 440 and 450 over network 405. In some implementations, the sensors 420, the module 422, the camera 430, the thermostat 434, and the robotic devices 490 are programmed, e.g., intelligent enough, to change the communication pathway from a direct local pathway when the one or more devices 440 and 450 are in close physical proximity to the sensors 420, the module 422, the camera 430, the thermostat 434, the robotic devices 490, or a combination of these, to a pathway over network 405 when the one or more devices 440 and 450 are farther from the sensors 420, the module 422, the camera 430, the thermostat 434, the robotic devices 490, or a combination of these.

In some examples, the monitoring system 460 leverages GPS information from the one or more devices 440 and 450 to determine whether the one or more devices 440 and 450 are close enough to the sensors 420, the module 422, the camera 430, the thermostat 434, the robotic devices 490, or a combination of these, to use the direct local pathway or whether the one or more devices 440 and 450 are far enough from the sensors 420, the module 422, the camera 430, the thermostat 434, the robotic devices 490, or a combination of these, that the pathway over network 405 is required. In some examples, the monitoring system 460 leverages status communications (e.g., pinging) between the one or more devices 440 and 450 and the sensors 420, the module 422, the camera 430, the thermostat 434, the robotic devices 490, or a combination of these, to determine whether communication using the direct local pathway is possible. If communication using the direct local pathway is possible, the one or more devices 440 and 450 communicate with the sensors 420, the module 422, the camera 430, the thermostat 434, the robotic devices 490, or a combination of these, using the direct local pathway. If communication using the direct local pathway is not possible, the one or more devices 440 and 450 communicate with the sensors 420, the module 422, the camera 430, the thermostat 434, the robotic devices 490, or a combination of these, using the pathway over network 405.

In some implementations, the environment 400 provides people with access to images captured by the camera 430 to aid in decision-making. The environment 400 can transmit the images captured by the camera 430 over a network, e.g., a wireless WAN, to the devices 440 and 450. Because transmission over a network can be relatively expensive, the environment 400 can use several techniques to reduce costs while providing access to significant levels of useful visual information (e.g., compressing data, down-sampling data, sending data only over inexpensive LAN connections, or other techniques).

In some implementations, a state of the environment 400, one or more components in the environment 400, and other events sensed by a component in the environment 400 can be used to enable/disable video/image recording devices (e.g., the camera 430). In these implementations, the camera 430 can be set to capture images on a periodic basis when the alarm system is armed in an “away” state, set not to capture images when the alarm system is armed in a “stay” state or disarmed, or a combination of both. In some examples, the camera 430 can be triggered to begin capturing images when the control unit 410 detects an event, such as an alarm event, a door-opening event for a door that leads to an area within a field of view of the camera 430, or motion in the area within the field of view of the camera 430. In some implementations, the camera 430 can capture images continuously, but the captured images can be stored or transmitted over a network when needed.

In some implementations, when a device or system transmits data to another device or system, the transmission of the data, such as a message, can cause the other device or system to perform one or more actions. For instance, transmission of a message that includes an instruction to a camera can cause the camera to capture one or more images, transmit one or more images to the device or system, or a combination of both.

Although FIG. 4 depicts the monitoring system 460 as remote from the control unit 410, in some examples the control unit 410 can be a component of the monitoring system 460. For instance, both the monitoring system 460 and the control unit 410 can be physically located at a property that includes the sensors 420 or at a location outside the property.

In some examples, some of the sensors 420, the robotic devices 490, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 410, the monitoring system 460, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user’s device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
maintaining a first image captured by a camera;
maintaining, for each of one or more second images, a corresponding difference image generated from the first image and the corresponding second image;
providing, to a deep motion detector trained to detect motion for an object of interest and to cause the deep motion detector to generate output, the one or more difference images and color image data for the first image;
receiving, from the deep motion detector, output that indicates whether the first image likely depicts motion for an object of interest; and
performing one or more automated actions using the output that indicates whether the first image likely depicts motion for an object of interest.

2. The method of claim 1, comprising:
receiving, from a camera that captured the first image, the first image; and
computing, for each of the one or more second images, the corresponding difference image.

3. The method of claim 2, wherein computing the corresponding difference image comprises:
downsampling a luminance value from the first image; and
for at least some of the one or more second images:
downsampling a luminance value from the corresponding second image; and
computing the corresponding difference image that indicates a difference between the downsampled luminance value from the first image and the downsampled luminance value from the corresponding second image.

4. The method of claim 3, comprising:
converting an image from an RGB color model to a YUV color model, the image comprising one of the first image or one of the one or more second images,
wherein downsampling the luminance value comprises downsampling the luminance value of the image in the YUV color model.

5. The method of claim 1, wherein:
providing the one or more difference images and the color image data causes the deep motion detector to combine first data for the one or more difference images with second data for the color image data; and
receiving the output comprises receiving the output generated using the combination of the first data and the second data.

6. The method of claim 5, wherein:
the deep motion detector comprises one or more convolutional layers, one or more downsampling layers, and one or more spatial attention modules; and
receiving the output comprises receiving the output generated by processing a) at least some of the one or more difference images with at least one of the one or more spatial attention modules to generate the first data, b) third data for the color image data with at least one of the one or more convolutional layers to generate convolutional output data, and c) at least some of the convolutional output data with at least one of the one or more downsampling layers to generate the second data.

7. The method of claim 6, wherein receiving the output comprises receiving the output generated by processing difference image data from the one or more difference images with each of the one or more spatial attention modules.

8. The method of claim 6, wherein:
the deep motion detector comprises one or more residual layers; and
receiving the output comprises receiving the output generated by processing the combination of at least some of the first data and at least some of the second data with at least one of the one or more residual layers.

9. The method of claim 8, wherein receiving the output comprises receiving the output generated by processing a final residual output from the one or more residual layers with one or more global average pool layers and one or more fully connected layers.

10. The method of claim 8, wherein receiving the output comprises receiving the output generated by processing, with at least one of the one or more residual layers, the first data concatenated with the second data.

11. The method of claim 1, wherein:
maintaining the corresponding difference image comprises maintaining, for each of two or more second images, the corresponding difference image generated from the first image and the corresponding second image; and
providing the one or more difference images and the color image data comprises providing, to the deep motion detector trained to detect motion for an object of interest and to cause the deep motion detector to generate output, the two or more difference images and color image data for the first image.

12. The method of claim 1, wherein performing the one or more automated actions comprises transmitting, to another system, a message that indicates that motion of an object of interest was detected in response to determining that the output indicates that the image likely depicts motion for an object of interest.

13. The method of claim 1, wherein:
receiving the output comprises receiving, from the deep motion detector, output that indicates, for each of multiple categories of objects of interest, whether the first image likely depicts motion for the respective category of an object of interest; and
performing the one or more automated actions comprises providing, to an object detector, the output that includes a value for each of the multiple categories of interest to cause the object detector to detect an object depicted in the first image.

14. The method of claim 1, wherein performing the one or more automated actions comprises removing the image from motion analysis of the first image for an object of interest in response to determining that the output indicates that the image likely does not depict motion for an object of interest.

15. A system comprising one or more computers and one or more storage devices on which are stored instructions that are operable, when executed by the one or more computers, to cause the one or more computers to perform operations comprising:
for at least one training image:
maintaining a reference image that depicts the same physical region as the corresponding training image;
computing a motion score that represents a ratio of a number of reference points that are at different locations in the reference image and the corresponding training image to a total number of reference points;
determining whether the motion score satisfies a score criterion; and
selectively labeling the corresponding training image as depicting motion or not depicting motion using a result of the determination whether the motion score satisfies the score criterion; and
updating a deep motion detector using the at least one training image as input during a training process.

16. The system of claim 15, wherein:
computing the motion score comprises, for each of one or more objects of interest depicted in the corresponding training image, computing the motion score that represents the ratio of the number of reference points for the corresponding object of interest that are at different locations in the reference image and the corresponding training image to the total number of reference points; and
determining whether the motion score satisfies the score criterion comprises determining whether at least one of the motion scores for the one or more objects of interest satisfy the score criterion.

17. The system of claim 16, wherein selectively labeling the corresponding training image as depicting motion or not depicting motion uses the result of the determination whether at least one of the one or more motion scores, each for a corresponding object of interest depicted in the corresponding training image, satisfy the score criterion.

18. The system of claim 16, the operations comprising:
receiving input defining the one or more objects of interest; and
detecting, for an image from the at least one training image, the reference points using data for the one or more objects of interest, wherein:
updating the deep motion detector uses a training process to cause the deep motion detector to detect motion of the one or more objects of interest.

19. The system of claim 15, wherein the total number of reference points comprises a total number of reference points in the corresponding training image.

20. One or more computer storage media encoded with instructions that, when executed by one or more computers, cause the one or more computers to perform operations comprising:
for at least one training image:
maintaining a reference image that depicts the same physical region as the corresponding training image;
computing a motion score that represents a ratio of a number of reference points that are at different locations in the reference image and the corresponding training image to a total number of reference points;
determining whether the motion score satisfies a score criterion; and
selectively labeling the corresponding training image as depicting motion or not depicting motion using a result of the determination whether the motion score satisfies the score criterion;
updating a deep motion detector using the at least one training image as input during a training process;
maintaining a first image captured by a camera;
maintaining, for each of one or more second images, a corresponding difference image generated from the first image and the corresponding second image;
providing, to the deep motion detector trained to detect motion for an object of interest and to cause the deep motion detector to generate output, the one or more difference images and color image data for the first image;
receiving, from the deep motion detector, output that indicates whether the first image likely depicts motion for an object of interest; and
performing one or more automated actions using the output that indicates whether the first image likely depicts motion for an object of interest.
